(19) United States
(12) Patent Application Publication
(10) Pub. No.: US 2012/0082288 A1
(43) Pub. Date: Apr. 5, 2012

(54) ARRANGEMENT FOR THE CONTACTLESS TRANSMISSION OF ENERGY AND CONTACTLESS TRANSMISSION OF DATA IN A COMPUTED TOMOGRAPHY SYSTEM

(76) Inventors: Horst Friesner, Altendorf (DE); Florian Hofmann, Erlangen (DE); Ulrich Kühn, Baiersdorf (DE); Thomas Luthardt, Bamberg (DE); Hans-Jürgen Müller, Pretzfeld (DE); Helmut Repp, Erlangen (DE); Edgar Schindler, Speichersdorf (DE); Ludwig Welker, Eggolsheim (DE); Marco del Antonio, Furth (DE)

(21) Appl. No.: 13/250,382

(22) Filed: Sep. 30, 2011

(30) Foreign Application Priority Data
Oct. 1, 2010 (DE) 10 2010 041 836.6

(51) Int. Cl. H05G 1/60

(52) U.S. Cl. 378/4

(57) ABSTRACT

The present embodiments relate to an arrangement for the contactless transmission of first electrical signals, second electrical signals and electrical energies between a fixed gantry part of a computed tomography system and a gantry part that may be rotated around an axis of rotation. The arrangement includes a first annular-shaped carrier ring arranged on the rotatable gantry part, at least a first conductor element arranged in or on the first annular-shaped carrier ring to receive the electrical energy, and at least a second conductor element arranged in or on the first annular-shaped carrier ring to output the first electrical signals.

This application claims the benefit of DE 10 2010 041 836.6, filed on Oct. 1, 2010.

### BACKGROUND

The present embodiments relate to an arrangement for the contactless transmission of data and energy between a fixed gantry part of a computed tomography system and a gantry part that may be rotated around an axis of rotation.

When a computed tomography system is in operation, data detected by one or more X-ray detectors is to be transmitted from a rotating part to a stationary part of the computed tomography system in order to further process the detected data. With the continuous development of computed tomography, the data quantity to be transmitted per unit of time continuously increases.

In many computer tomographs, a slip ring system is used for data transmission, as is known, for example, from U.S. Pat. No. 5,140,696 A. This data transmission system includes a transmitter unit on the rotating part and a receiver unit on the stationary part. The transmitter unit has at least one high-frequency line connected to the transmitter as a transmit antenna. The transmit antenna is arranged on the circumference of the rotating part of the rotating frame. The receiver unit includes a receiver and at least one receiver antenna connected to the receiver. The at least one receiver antenna is formed by a short section of a high frequency line. When the computer tomograph is in operation, the transmit antenna moves a small distance past the receiver antenna fastened to the stationary part, so that signals propagated on the transmitting high frequency line create crosstalk in a near field on the receiver antenna.

In addition to the data, energy for power supply is to be transmitted from the stationary part to the rotating part (e.g., for the X-ray tube).

### SUMMARY AND DESCRIPTION

The present embodiments may obviate one or more of the drawbacks or limitations in the related art. For example, an improved arrangement for the transmission of electrical data and electrical energy between two gantry parts of a computed tomography system that rotate relative to one another may be provided.

The present embodiments include an arrangement for the contactless transmission of first electrical signals, second electrical signal, and electrical energies between a fixed gantry part of a computed tomography system and a gantry part that may be rotated around an axis of rotation. The arrangement includes a first annular-shaped carrier ring that is arranged on the rotatable gantry part, at least a first conductor element that is arranged in or on the first carrier ring to receive an electrical energy, and at least a second conductor element arranged in or on the first carrier ring to output the first electrical signals. The present embodiments offer the advantage of saving costs and installation space and reducing assembly effort through the integration of data transmission and transmission of energy in a carrier ring.

In one embodiment, the arrangement may include a second annular-shaped carrier ring arranged on the fixed gantry part, at least a third conductor element arranged in or on the second carrier ring to output electrical energy, and at least a fourth conductor element arranged in or on the second carrier ring to receive the first electrical signals.

In another embodiment, the arrangement may include at least a fifth conductor element arranged in or on the second carrier ring to output the second electrical signals.

The arrangement may include at least a sixth conductor element arranged in or on the first carrier ring to receive the second electrical signals.

The first conductor element and the third conductor element may be embodied as annular-shaped.

In one embodiment, the second conductor element and the fourth conductor element may be embodied as annular-shaped.

In another embodiment, the fifth conductor element and the sixth conductor element may be embodied as annular-shaped.

The first conductor element may include concentrically arranged first metal windings in a first ferrite.

The third conductor element may include second metal windings concentrically arranged in a second ferrite.

In one embodiment, the number of first metal windings may be larger than the number of second metal windings.

In another embodiment, at least a first transmitter module may be arranged on the first carrier ring. The first transmitter module feeds the first electrical signals into the second conductor element.

At least a first receiver module may be arranged on the second carrier ring. The first receiver module couples the first electrical signals from the fourth conductor element.

The present embodiments also include a computed tomography system including a gantry with two gantry parts and one embodiment of an arrangement.

### BRIEF DESCRIPTION OF THE DRAWINGS

FIG. 1 shows one embodiment of a computed tomography system;

FIG. 2 shows a cross-section through one embodiment of an arrangement including a first carrier ring and a second carrier ring with an energy transmission line; and

FIG. 3 shows a cross-section through one embodiment of an arrangement including a first carrier ring and a second carrier ring with two energy transmission lines.

### DETAILED DESCRIPTION OF THE DRAWINGS

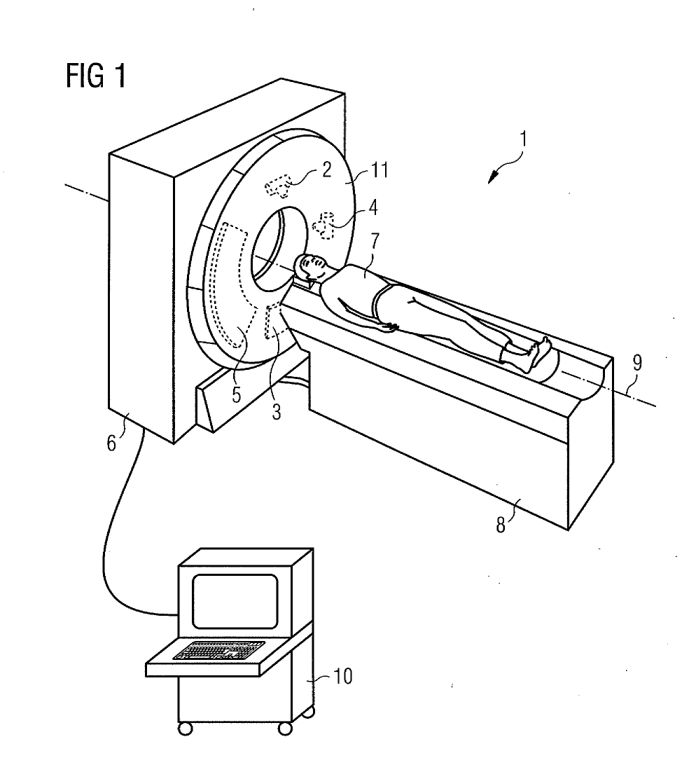

FIG. 1 shows one embodiment of a computed tomography system 1 with a fixed gantry part 6, fitted with a rotatable gantry part 11, on which a first tube/detector system is arranged. The first tube/detector system includes an X-ray tube 2 and a detector 3. Alternatively, one or more additional tube/detector systems may be mounted, as shown in FIG. 1 optionally with the X-ray tube 4 and the detector 5 lying opposite. For examination, a patient 7 is introduced into a measuring field with the aid of a patient couch 8 that may be pushed along a system axis 9, so that an absorption of the X-ray radiation may be measured from different projection angles. A computer 10 that is designed as a control and processing unit serves to control the system 1. Computer programs run on the computer 10 and perform control of the system 1, the analysis of measured data, and reconstruction of the desired tomographic image data.

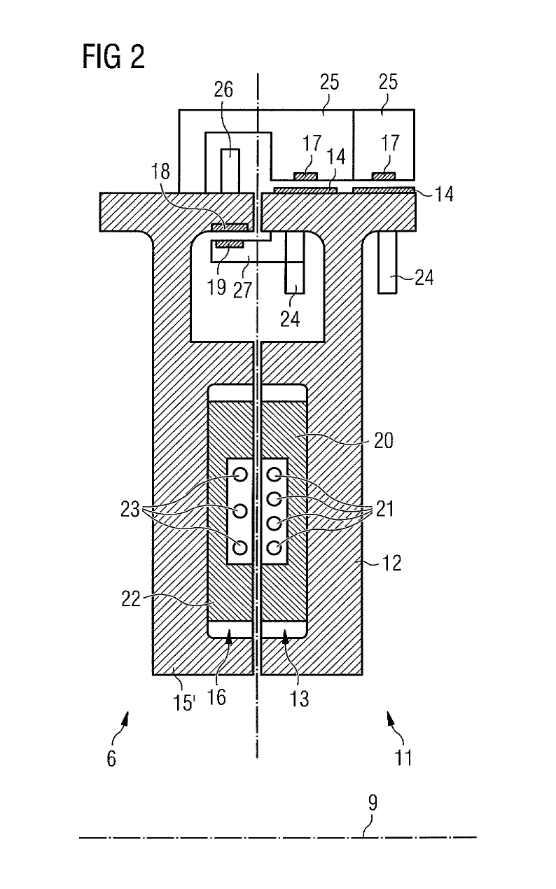

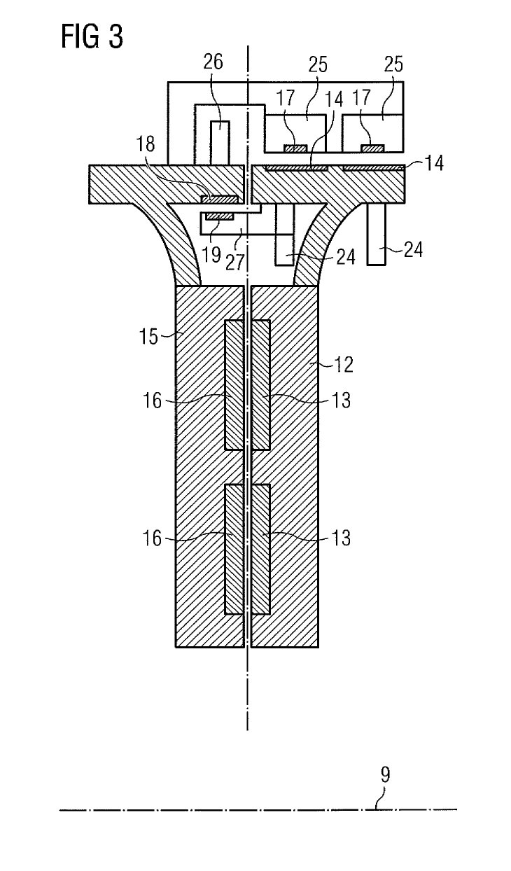

For example, when detector data is transmitted from the at least one detector to the rotatable gantry part 11, a large quantity of obtained data may be transmitted to the fixed gantry part 6. Electrical energy, for example, for the supply of X-ray tubes, is to be transmitted from the fixed gantry part 6 to the rotatable gantry part 11. One embodiment of an arrangement for the contactless transmission of electrical signals and electrical energy is mounted to the rotatable gantry part 11 and the fixed gantry part 6. Signals and energy may be transmitted between the fixed gantry part 6 and the rotatable gantry part 11, which may be rotated relative to one another. Exemplary embodiments of the arrangement are shows in more detail in FIGS. 2 and 3.

FIG. 2 shows one embodiment of an arrangement with a first annular-shaped carrier ring 12 (e.g., a first carrier ring) and a second annular-shaped carrier ring 15 (e.g., a second carrier ring) in cross-section. The first carrier ring 12 and the second carrier ring 15 are made, for example, of aluminum or steel. The first carrier ring 12 is fastened to the rotatable gantry part 11 of the computed tomography system in a rotationally symmetrical manner around an axis of rotation 9 of the computed tomography system. The first carrier ring 12 rotates around the axis of rotation 9 during a rotation of the rotatable gantry part 11. The second carrier ring 15 is correspondingly fastened to the first carrier ring 12 on the fixed gantry part 6 of the computed tomography system in a rotationally symmetrical manner around the axis of rotation 9.

Integrated in the first carrier ring 12 is a first annular-shaped conductor element 13 (e.g., a first conductor element) for the contactless take-up of electrical energy. The first conductor element 13 includes a first ferrite 20 and first metal windings 21 embedded in the first ferrite 20. The first metal windings 21 inductively receive the electrical energy and convert the electrical energy into a power for the supply of electrical components. Two second annular-shaped conductor elements 14 (e.g., second conductor elements) are arranged on the first carrier ring 12. The second conductor elements are provided for transmitting first electrical signals. Using first transmit modules 24, the first electrical signals, which contain data to be transmitted, are fed into the second conductor elements 14. Second electrical signals are contactlessly received via an annular-shaped sixth conductor element 19 (e.g., a sixth conductor element) also connected to the first carrier ring 12. The second electrical data received is processed in a second receiver module 27.

An annular-shaped third conductor element 16 (e.g., a third conductor element) is integrated in the stationary-mounted second carrier ring 15, which outputs electrical signals that are contactlessly received by the first conductor element 13. The third conductor element 16 includes a second ferrite 22, in which second metal windings 23 are embedded. For example, the number of second metal windings 23 is smaller than the number of first metal windings 21, so that an electrical voltage transformation occurs during a transfer of energy from the second carrier ring 15 to the first carrier ring 12.

Two fourth conductor elements 17 are connected to the second carrier ring 15. The fourth conductor elements 17 receive the first electrical signals output from the second conductor elements 14 and conduct the first electrical signals to the first receiver module 25 for further processing. In addition, a fifth conductor element 18 is arranged on the second carrier ring 15. The fifth conductor element 18 contactlessly transmits the second electrical signal to the sixth conductor element 19. The second electrical signal forms a second transmitter module 26 and is fed into the fifth conductor element 18.

The second conductor element 14, the fourth conductor element 17, the fifth conductor element 18 and the sixth conductor element 19 may be formed from a copper sheet.

Costs and implementation space are saved by the integration of transmission of data and transmission of energy in a carrier ring, and less time and effort is required for assembly.

FIG. 3 shows one embodiment of an arrangement modified in relation to FIG. 2, with a first annular-shaped carrier ring 12 (e.g., a first carrier ring) and a second annular-shaped carrier ring 15 (e.g., a second carrier ring) in cross-section. The two first carrier ring 12 and the second carrier ring 15 are made, for example, of aluminum or steel. The first carrier ring 12 is mounted on the rotatable gantry part 11 of the computed tomography system in a manner that is rotationally symmetrical around the axis of rotation 9 of the computed tomography system. The first carrier ring 12 rotates around the axis of rotation 9 when the rotatable gantry part 11 rotates. The second carrier ring 15 is correspondingly attached to the first carrier ring 12 on the fixed gantry part 6 of the computed tomography system in a rotationally symmetrical manner to the axis of rotation 9.

Two annular-shaped first conductor elements 13 (e.g., first conductor elements) are integrated in the first carrier ring 12 for the contactless absorption of electrical energies. The first conductor elements 13 may include ferrite and metal windings embedded therein. The metal windings inductively take up the electrical energies and convert the electrical energies into a power for supplying electrical components. Two annular-shaped second conductor elements 14 (e.g., second conductor elements) are also arranged on the first carrier ring 12. The second conductor elements 14 are provided to transmit first electrical signals. Electrical signals, which contain data to be transmitted, are fed into the second conductor elements 14 by first transmitter modules 24. Second electrical signals are contactlessly received via a sixth annular-shaped conductor element 19 (e.g., a sixth conductor elements) that is also connected to the first carrier ring 12. The received second electrical signals are processed in a second receiver module 27.

Integrated in the stationary-mounted second carrier ring 15 are two annular-shaped third conductor elements 16 (e.g., third conductor elements) that output electrical energies that are contactlessly received by the first conductor elements 13. The third conductor elements 16 may include ferrites, in which metal windings are embedded.

Two fourth conductor elements 17 are also connected to the second carrier ring 15. The two fourth conductor elements 17 receive first electrical signals output by the second conductor elements 14 and output the first electrical signals to the first receiver module 25 for further processing. In addition, a fifth conductor element 18 is arranged on the second carrier ring 15. The fifth conductor element 18 transmits the second electrical signal contactlessly to the sixth conductor element 19. The second electrical signal forms a second transmitter module 26 and is fed into the fifth conductor element 18.

With the aid of the arrangement of FIG. 3, different electrical energies may be transmitted.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An arrangement for the contactless transmission of first electrical signals, second electrical signals, and electrical energy between a fixed gantry part of a computed tomography system and a gantry part that is rotatable around an axis of rotation, the arrangement comprising:
a first annular-shaped carrier ring arranged on the rotatable gantry part;
at least a first conductor element arranged in or on the first annular-shaped carrier ring, the first conductor element being configured to receive the electrical energy; and
at least a second conductor element arranged in or on the first annular-shaped carrier ring, the second conductor element being configured to output the first electrical signals.

2. The arrangement as claimed in claim 1, further comprising:
a second annular-shaped carrier ring arranged on the fixed gantry part;
at least a third conductor element arranged in or on the second annular-shaped carrier ring to output the electrical energy; and
at least a fourth conductor element arranged in or on the second annular-shaped carrier ring to receive the first electrical signals.

3. The arrangement as claimed in claim 2, further comprising at least a fifth conductor element arranged in or on the second annular-shaped carrier ring, the fifth conductor element being configured to output the second electrical signals.

4. The arrangement as claimed in claim 3, further comprising at least a sixth conductor element arranged in or on the first annular-shaped carrier ring, the sixth conductor element being configured to receive the second electrical signals.

5. The arrangement as claimed in claim 2, wherein the first conductor element and the third conductor element are annular-shaped.

6. The arrangement as claimed in claim 2, wherein the second conductor element and the fourth conductor element are annular-shaped.

7. The arrangement as claimed in claim 4, wherein the fifth conductor element and the sixth conductor element are annular-shaped.

8. The arrangement as claimed in claim 1, wherein the first conductor element comprises metal windings that are arranged concentrically in a ferrite.

9. The arrangement as claimed in claim 2, wherein the third conductor element comprises metal windings concentrically arranged in a ferrite.

10. The arrangement as claimed in claim 8, wherein the metal windings are first metal windings,
wherein the third conductor element comprises second metal windings, and
wherein the number of first metal windings is larger than the number of second metal windings.

11. The arrangement as claimed in claim 1, wherein at least a first transmitter module is arranged on the first annular-shaped carrier ring, the first transmitter module feeding the first electrical signals into the second conductor element.

12. The arrangement as claimed in claim 2, wherein at least a first receiver module is arranged on the second annular-shaped carrier ring, the first receiver module coupling the first electrical signals from the fourth conductor element.

13. The arrangement as claimed in claim 3, wherein the first conductor element and the third conductor element are annular-shaped.

14. The arrangement as claimed in claim 4, wherein the first conductor element and the third conductor element are annular-shaped.

15. The arrangement as claimed in claim 4, wherein the second conductor element and the fourth conductor element are annular-shaped.

16. The arrangement as claimed in claim 5, wherein the second conductor element and the fourth conductor element are annular-shaped.

17. The arrangement as claimed in claim 9, wherein the first conductor comprises first metal windings,
wherein the metal windings are second metal windings, and
wherein the number of first metal windings is larger than the number of second metal windings.

18. The arrangement as claimed in claim 2, wherein at least a first transmitter module is arranged on the first annular-shaped carrier ring, the first transmitter module feeding the first electrical signals into the second conductor element.

19. The arrangement as claimed in claim 4, wherein at least a first receiver module is arranged on the second annular-shaped carrier ring, the first receiver module coupling the first electrical signals from the fourth conductor element.

20. A computed tomography system comprising:
a gantry with a fixed gantry part and a gantry part that is rotatable around an axis of rotation; and
an arrangement for the contactless transmission of first electrical signals, second electrical signals, and electrical energy between the fixed gantry part and the rotatable gantry part, the arrangement comprising:
a first annular-shaped carrier ring arranged on the rotatable gantry part;
at least a first conductor element arranged in or on the first annular-shaped carrier ring, the first conductor element being configured to receive the electrical energy; and
at least a second conductor element arranged in or on the first annular-shaped carrier ring, the second conductor element being configured to output the first electrical signals.
